(19) United States
(12) Patent Application Publication
(10) Pub. No.: US 2026/0151836 A1
(43) Pub. Date: Jun. 4, 2026

(54) CUTTING TOOL AND INDEXABLE INSERT

(71) Applicant: Kennametal Inc., Latrobe, PA (US)

(72) Inventor: Frank FUNKE, Friedrichsdorf (DE)

(21) Appl. No.: 19/460,616

(22) Filed: Jan. 27, 2026

Related U.S. Application Data
(63) Continuation of application No. 18/008,087.

(30) Foreign Application Priority Data
Jun. 3, 2020 (DE) 102020114722.8

(51) Int. Cl. B23B 51/10

(52) U.S. Cl. CPC B23B 51/101

(57) ABSTRACT

The invention relates to a cutting tool, in particular a chamfering tool. The tool comprises a tool body which is rotatable about a tool axis and a chamfer cutting element which is mounted on the tool body such that it is radially displaceable by a guide. The chamfer cutting element is held in radial direction on the tool body by a holding arm. The holding arm is elastically flexible in radial direction and is disposed at least partly inside a substantially axially extending groove provided on an outer periphery of the tool body. Also presented is an indexable insert for such a cutting tool.

### CROSS-REFERENCE TO RELATED APPLICATIONS

The present application is a continuation of and claims priority to U.S. patent application Ser. No. 18/008,087, filed Dec. 2, 2022, which claims priority to PCT Application No. PCT/EP2021/064821, filed Jun. 2, 2021, which claims priority to German Patent Application No. 102020114722.8, filed Jun. 3, 2020, each of which are incorporated herein by reference in their entireties.

### BACKGROUND INFORMATION

The invention relates to a cutting tool, in particular a chamfering tool, having a tool body which is rotatable about a tool axis. Further provided is a chamfer cutting element which is mounted on the tool body such that it is radially displaceable by means of a guide, whereby at least one forward chamfer cutting edge and at least one reverse chamfer cutting edge are provided on the chamfer cutting element. The cutting tool also comprises a holding arm separate from the chamfer cutting element, which holds the chamfer cutting element in radial direction on the tool body and is elastically flexible in radial direction.

The invention further relates to an indexable insert for such a cutting tool.

### SUMMARY OF THE INVENTION

Such cutting tools and indexable inserts are known from the state of the art. A chamfering tool is a cutting tool that is configured to produce chamfers. Chamfering tools with rotatable tool bodies are used in particular to create chamfers on the edges of bores.

In this context, a forward chamfer cutting edge is a cutting edge configured to produce a chamfer, which is disposed on the tool body in such a way that it can produce a chamfer on an associated workpiece during a forward movement of the cutting tool. A forward movement corresponds to an insertion movement. Correspondingly, a reverse chamfer cutting edge is a cutting edge configured to produce a chamfer, which is disposed on the tool body in such a way that it can create a chamfer on the associated workpiece during a reverse movement of the cutting tool. A reverse movement is opposite to the insertion movement and therefore corresponds to withdrawing the tool from the workpiece. Since creating chamfers at the corresponding locations also removes burrs, such cutting tools are also referred to as deburring tools.

Cutting tools of the abovementioned type are constructed in such a way that, in an unloaded state, which is also referred to as the neutral state, the forward chamfer cutting edge and/or the reverse chamfer cutting edge project(s) radially with respect to the tool body. During machining, however, the chamfer cutting element can be pushed back radially into the tool body at least partly, if cutting forces acting radially on the chamfer cutting element are large enough to elastically deform the holding arm.

In known cutting tools, the holding arm is typically disposed inside the tool body.

Cutting tools are also known, in which the chamfer cutting element can be pushed back radially against a spring-loaded pin accommodated centrally inside the tool body.

The object of the invention is to further simplify known cutting tools in terms of their structure. The intent is to create cutting tools that are robust and reliable in operation and at the same time inexpensive to produce.

The object is achieved by a cutting tool, in particular a chamfering tool, having a tool body which is rotatable about a tool axis, which comprises a chamfer cutting element that is mounted on the tool body such that it is radially displaceable by means of a guide. At least one forward chamfer cutting edge and at least one reverse chamfer cutting edge are provided on the chamfer cutting element. The cutting tool also comprises a holding arm separate from the chamfer cutting element, which holds the chamfer cutting element in radial direction on the tool body and is elastically flexible in radial direction. The holding arm is disposed at least partly inside a substantially axially extending groove provided on an outer periphery of the tool body. A groove, by definition, is open only on one side. This means that a groove always has a groove base. The groove provided on the outer periphery of the tool body is therefore not continuous in radial direction. Since the holding arm is disposed in such a groove, one side is accessible from the outside. Therefore the cutting tool does not have to be removed from an associated machine to inspect, modify, assemble or disassemble the holding arm. This is equally possible when the cutting tool is clamped. Furthermore, due to its position inside the groove, the holding arm does not project radially relative to the tool body. The cutting tool can thus reach through-bores and other openings without undesirable interactions between the workpiece and the holding arm. Such a cutting tool has a simple structure and can therefore be produced and used cost-effectively.

The holding arm can also be disposed entirely within the groove provided on the outer periphery of the tool body.

A cutting bit can be disposed on a front end of the tool body. The cutting tool is then a drilling tool. Consequently, such a drilling tool can be used to drill a hole and provide the edges of the hole with a chamfer in a single working step. This applies in particular to through holes, for which such a tool can be used to produce chamfers on either side of the hole edges.

The cutting bit can be configured directly on the tool body. The cutting bit can alternatively be provided on a drill tip separate from the tool body, in particular a drill tip made of hard metal. It is also possible for the cutting bit to be provided on a cutting insert, in particular an indexable insert, which is fastened to the tool body.

The holding arm preferably extends substantially in axial direction. The structure of the cutting tool is therefore simple and compact. Moreover, the elastic flexibility of the holding arm can easily be implemented with this configuration. In this context, holding arms that extend substantially in axial direction also include holding arms that are inclined by a few degrees relative to the axial direction. For example, a holding arm is inclined 1° to 5° relative to the axial direction. Of course, the holding arm can also extend parallel to the axial direction.

The holding arm can comprise a first, axially forward end, which engages in an associated depression on the chamfer cutting element. The front end of the holding arm and the depression on the chamfer cutting element thus create a form fit which acts in radial direction. As a result, the chamfer cutting element is reliably held on the cutting tool in this direction. The holding arm and the chamfer cutting element can moreover easily be coupled and decoupled from one another. The chamfer cutting element can thus be replaced comparatively quickly and easily, for example.

By means of the holding arm, the chamfer cutting element is preferably held on the tool body under radial pretension. Said pretension acts radially outward. Therefore, in order to move the chamfer cutting element radially into the tool body, the pretensioning force generated by the holding arm has to be overcome. As a result, on the one hand, the chamfer cutting element is held particularly reliably and precisely on the tool body. On the other hand, the pretensioning prevents undesirable relative movements between the chamfer cutting element and the tool body and also the holding arm. Undesirable noises, in particular rattling, can thus effectively be prevented as well.

The holding arm can also comprise a second, axially rear end, which is fastened to the tool body. The axially rear end is in particular clamped or screwed to the tool body. The holding arm is therefore reliably fastened to the tool body via the second end. The fastening, i.e. for example the clamp or screw connection, is preferably accessible from outside the tool body. The second end of the holding arm can also be fastened to or detached from the tool body in the clamped state of said tool body.

In one variant, a recess is provided on the tool body adjacent in radial direction to at least one axially forward region of the holding arm. Said recess is configured to receive the holding arm in the event of a radially inward elastic deformation. As already mentioned, the holding arm is elastically deformed radially inward when a cutting force acting in radial direction on the chamfer cutting element is greater than a pretensioning force emanating from the holding arm. The recess allows a geometrically unobstructed deformation of the holding arm. As a result, the chamfer cutting element is reliably and reproducibly always pushed into the tool body at the same cutting force acting in radial direction.

The receptacle is preferably implemented as a portion of the groove provided on the outer periphery of the tool body. This structure is particularly simple.

The recess advantageously extends from the axially forward end of the holding arm over at least 50% of the length of the holding arm. The recess in particular extends over at least 65% of the length of the holding arm. The recess can also extend over at least 80% of the length of the holding arm. Sufficient freedom of movement for the holding arm is thus provided for all operating situations.

According to one embodiment, a bending abutment element for the holding arm is disposed inside the recess. The bending abutment element is mounted on the tool body such that it is axially adjustable. The holding arm is thus elastically deformable in particular between its front end and the bending abutment element. A deformation characteristic of the holding arm can thus be set via the axial adjustment of the bending abutment element. In other words, it is possible to control the spring properties of the holding arm. The bending abutting element can similarly be used to set a pretensioning force, by means of which the chamfer cutting element is held on the tool body in radial direction.

In one variant, positions for the bending abutment element are predetermined on the tool body and/or on the holding arm. The deformation characteristics of the holding arm and the pretensioning force can thus be set in a simple, reproducible manner. In this context, it is conceivable to predetermine the positions for the bending abutment element by means of bores for fastening pins. It is also possible to provide a plurality of grooves on the tool body and/or on the holding arm, in which the bending abutment element can selectively be disposed. Alternatively, one or more toothed portions can be provided as well, in which the bending abutment element can selectively engage.

The guide can be formed by a guide channel extending in radial direction in the tool body, into which at least a portion of the chamfer cutting element is inserted. The guide channel is open on one side. A cross-section of the guide channel corresponds substantially in terms of its size and shape to a cross-section of the chamfer cutting element which is oriented perpendicular to a central axis of the guide channel. A portion of the chamfer cutting element can thus be displaced only in radial direction within the guide channel. It goes without saying that at least a part of the chamfer cutting element has to project from the guide channel in order to be able to produce chamfers.

In one variant, the tool body comprises a cooling channel which extends substantially axially and substantially over the entire length of the tool body. The cooling channel is in particular fluidically connected to the guide channel. Any coolant can flow through the cooling channel. Therefore, if the cutting tool comprises a cutting bit, the cutting bit and an associated machining zone can be reliably cooled. If the cooling channel is fluidly connected to the guide channel, the at least one forward chamfer cutting edge and the at least one reverse chamfer cutting edge can also be reliably cooled via the guide channel. A coolant flow within the guide channel furthermore prevents unwanted particles in the form of dirt or chips from entering the guide channel. This effect can also be achieved if air is brought into the cooling channel as a coolant. In the guide channel, this air then acts as sealing air, which prevents the entry of foreign particles.

The chamfer cutting element can be an indexable insert. Consequently, it has a plurality of cutting edges and can be used in various installation positions to produce chamfers. An associated cutting tool is particularly efficient and cost-effective to operate.

The holding arm is preferably strip-shaped. The holding arm is in particular configured as a sheet metal strip. In this context, the holding arm can also be referred to as a leaf spring. The chamfer cutting element can thus be held reliably on the tool body. This applies in particular when the chamfer cutting element is held under pretension. Such a holding arm can furthermore be produced in a simple and cost-effective manner.

The holding arm is preferably designed such that it projects over the chamfer cutting element on both sides in circumferential direction. Viewed radially, therefore, the holding arm is wider in circumferential direction than the chamfer cutting element. This results in a reliable coupling of the chamfer cutting element to the holding arm.

A stop element can be provided on the tool body for limiting a displacement path of the chamfer cutting element radially outward. Such a limitation also limits the width of a chamfer that can be produced using the cutting tool. This furthermore prevents the chamfer cutting element from projecting in an undesirable manner with respect to the tool body, for example due to the effect of centrifugal forces. The stop element can also form an abutment for the chamfer cutting element against which it is pretensioned by means of the holding arm. This results in a defined position of the chamfer cutting element on the tool body.

The stop element is advantageously adjustable in its radial position. The stop element is in particular a stop screw that is radially screwed into the tool body. A maximum width of a chamfer that can be produced by means of the cutting tool can consequently be set. This can be achieved in a particularly simple manner if the stop element is a stop screw. Chamfers of different widths can thus be produced by means of the cutting tool.

The object is further achieved by an indexable insert for a cutting tool according to the invention, the indexable insert body of which, in a first alternative, comprises a respective depression on two opposite sides that is configured to interact with one end of a holding arm. The depressions are offset to one another along a direction parallel to the two opposite sides. In a second alternative, two depressions, which are configured to interact with one end of the holding arm, are provided on the same side of the indexable insert body. The depressions can alternatively interact with the end of the holding arm. Each depression is associated with an installation position of the indexable insert on the cutting tool. Such an indexable insert can therefore be used in at least two installation positions on the cutting tool. This results in a cutting tool that is particularly efficient in operation.

### BRIEF DESCRIPTION OF THE DRAWINGS

The invention is explained below with the aid of different design examples, which are shown in the accompanying drawings. The figures show:

FIG. 1 a cutting tool according to the invention comprising an indexable insert according to the invention in a side view,

FIG. 2 the cutting tool and the indexable insert of FIG. 1 in a partly sectional illustration along Line II-II in FIG. 1,

FIG. 3 in a schematic illustration, the cutting tool of FIGS. 1 and 2, wherein an adjustable bending abutment element is in a changed position compared to FIG. 2,

FIG. 4 an illustration corresponding to FIG. 3, wherein the bending abutment element is still in a changed position,

FIG. 5 a portion of a cutting tool according to the invention according to an alternative embodiment, which comprises an indexable insert according to an alternative embodiment, in a partly sectional illustration,

FIG. 6 the indexable insert according to the invention of the cutting tool of FIGS. 1 to 4 in an isolated illustration, and

FIG. 7 the indexable insert according to the invention of the cutting tool of FIG. 5 in an isolated illustration.

FIG. 8 shows a cutting tool 10 comprising a tool body 14 which is rotatable about a tool axis 12.

### DETAILED DESCRIPTION

It comprises a rear tool shank side end 16 and a front tool tip side end 18.

A drill tip 20 made of hard metal is fixedly connected to the tool body 14 on the tool tip side end 18. A plurality of cutting bits 22 are provided on the drill tip 20.

A chamfer cutting element 24 is furthermore provided on the tool body 14.

It comprises a forward chamfer cutting edge 26 and a reverse chamfer cutting edge 28.

The chamfer cutting element 24 is implemented as an indexable insert 30.

The cutting tool 10 is thus suitable both for drilling a hole and for creating chamfers on the edges of the hole. It is therefore a combination drilling-chamfering tool.

The chamfer cutting element 24 is mounted on the tool body 14 such that it is radially movable by means of a guide 32.

The guide 32 is formed by a guide channel 34 which extends in radial direction inside the tool body 14. It is radially open on one side (in the illustration according to FIG. 2 at the top).

A portion of the chamfer cutting element 24 is inserted into this guide channel 34.

A cross-section of the guide channel 34 corresponds substantially to a cross-section of the chamfer cutting element 24 along a guide channel center axis. Movements of the chamfer cutting element 24 beyond the radial mobility are thus excluded.

Since the guide channel 34 is open on only one side, a radially inward mobility of the chamfer cutting element 24 is limited as well.

In order to also limit the radially outward mobility of the chamfer cutting element 24, a stop element 36 in the form of a stop screw 38, which is screwed into the tool body 14 in radial direction, is provided on the tool body 14.

The stop screw 38 is implemented such that its screw head 40 limits a displacement path of the chamfer cutting element 24.

The position of the stop element 36 can be adjusted by screwing the stop screw 38 further or less far into the tool body 14.

The chamfer cutting element 24 is furthermore held in radial direction on the tool body 14 by means of a holding arm 42.

The holding arm 42 is separate from the chamfer cutting element 24.

It is also essentially strip-shaped.

In the embodiment shown, the holding arm 42 is configured as a sheet metal strip.

The holding arm 42 extends substantially in axial direction.

Moreover, a first, axially forward end 44 of the holding arm 42 engages in an associated depression 46 on the chamfer cutting element 24.

A second, axially rear end 48 of the holding arm 42 is fastened to the tool body 14.

In the embodiment shown, the rear end 48 is fixed to the tool body 14 by means of a fastening plate 50 which is oriented transversely to the holding arm 42. The fastening plate 50 is mounted on the tool body 14 by means of two screws 52, 54. The holding arm 42 is clamped between the fastening plate 50 and the tool body 14.

The holding arm 42 is disposed entirely inside a groove 56, which is provided on the tool body 14 and extends substantially axially.

The holding arm 42 is thus always located inside a substantially cylinder jacket shaped envelope surface, which corresponds to an outer periphery of the portions of the tool body 14, which are configured to come into contact with the workpiece during drilling. These portions are in particular located axially between the tool tip side end 18 and the fastening plate 50.

The holding arm 42 therefore does not project in radial direction relative to the tool body 14.

The holding arm 42 is also configured to be elastically flexible in radial direction.

Using this property, the holding arm 42 in the embodiment shown pretensions the chamfer cutting element 24 in radial direction against the stop element 36.

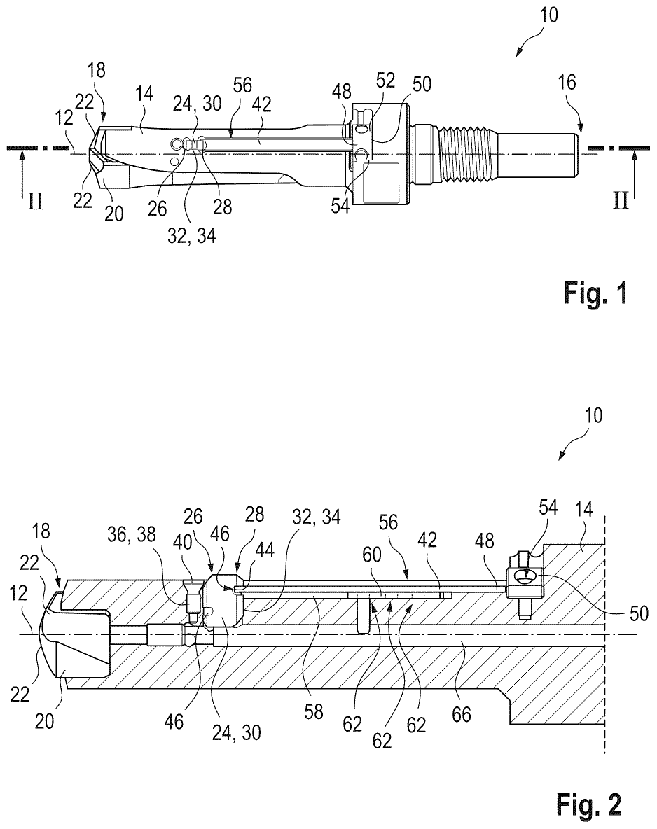

Therefore, in a neutral position (see FIGS. 1 and 2), the chamfer cutting element 24 rests against the screw head 40 of the stop screw 38 under pretension. In this context, the first end 44 of the holding arm 42 also rests against a radially outer boundary surface of the depression 46 of the chamfer cutting element 24.

To enable the holding arm 42 to also move inward in radial direction as needed, a recess 58 is provided on the tool body 14 adjacent to its axially forward region. Said recess is configured to receive the holding arm 42 in the event of a radially inward elastic deformation.

In the example shown, the recess 58 extends from the front end 44 of the holding arm 42 over approximately 80% of the length of the holding arm 42.

The recess 58 is furthermore configured as a recessed portion of the groove 56.

A bending abutment element 60 is disposed inside the recess 58. The holding arm 42 rests against it in the neutral state (see FIG. 2).

In the event that the holding arm 42 is to be bent radially inward, bending can take place in a region between the first end 44 and the bending abutment element 60.

The portion of the holding arm 42 which projects relative to the bending abutment element 60 in the direction of the first end 44 thus represents a type of cantilever beam.

The forces required for elastic deformation of the holding arm 42 are in particular dependent on a length of the portion which projects relative to the bending abutment element 60.

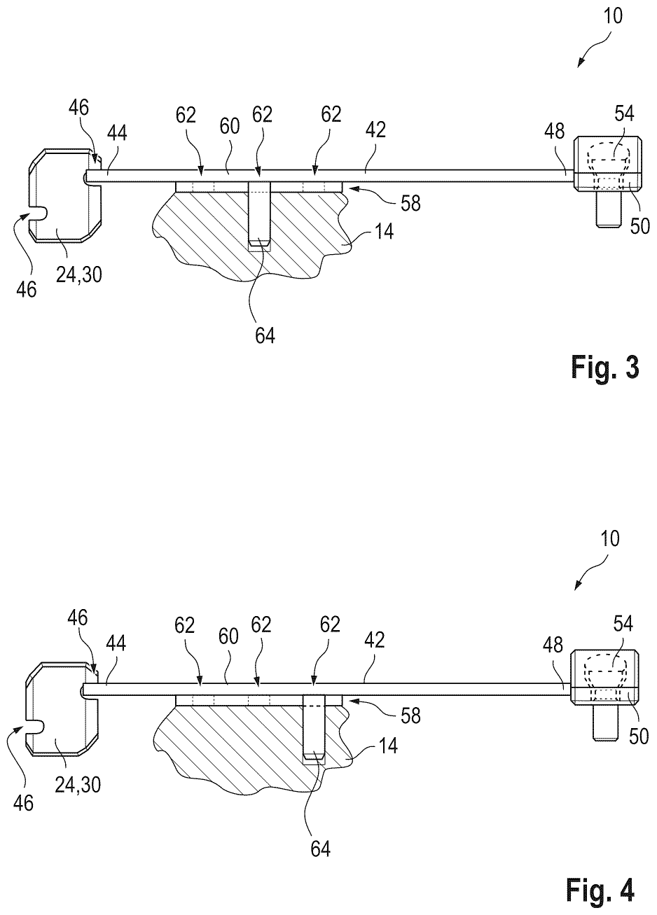

To control this, the bending abutment element 60 is mounted on the tool body such that it is axially adjustable (see FIGS. 2 to 4).

For this purpose, the bending abutment element 60 is configured as an abutment plate comprising a total of three fastening openings 62.

A fastening pin 64 is additionally provided on the tool body 14 for fastening the bending abutment element 60.

A size of the portion of the holding arm 42 which projects relative to the bending abutment element 60 can thus be adjusted by connecting the bending abutment element 60 to the fastening pin 64 using different fastening openings 62. In this context, FIGS. 2 to 4 show different positions.

The number of three fastening openings 62, which selectively interact with the fastening pin 64, is to be understood as an example. Of course, more or fewer than three fastening openings 62 can be provided as well, which results in more or fewer than three adjustable positions of the bending abutment element 60.

The distances between the fastening openings 62 can also be selected substantially freely. It is therefore possible to provide a cutting tool 10 depending on the specific application, in which the distances between the fastening openings 62 are of a suitable size.

The cutting tool 10 is also provided with a cooling channel 66 which extends substantially axially and substantially over the entire length of the tool body 14. Any coolant can be conducted to the cutting bits 22 via this cooling channel.

The cooling channel 66 is furthermore fluidically connected to the guide channel 34. Coolant can thus also be conducted to the forward chamfer cutting edge 26 and to the reverse chamfer cutting edge 28 of the chamfer cutting element 24.

The cutting tool 10 according to FIGS. 1 to 4 can be operated as follows.

The cutting tool 10 is set in rotation about the tool axis 12 and moved in the direction of a workpiece to be machined.

As soon as the cutting bits 22 come into contact with the workpiece, they begin to drill a hole. The cutting tool 10 is moved along the tool axis 12 in the direction of the workpiece in accordance with the drilling progress.

As soon as the workpiece and the cutting tool 10 assume a relative position in which the forward chamfer cutting edge 26 comes into contact with the workpiece, said cutting edge begins to produce a chamfer on an entry-side edge of the hole.

In doing so, cutting forces act on the chamfer cutting element 24.

As soon as the cutting forces acting in radial direction in this context exceed the pretensioning force applied to the chamfer cutting element 24 by means of the holding arm 42, the chamfer cutting element 24 is displaced radially inward, into the tool body, with elastic deformation of the holding arm 42.

If a through-bore is being produced by means of the cutting tool 10, the chamfer cutting element 24 does not leave this back-shifted position until it exits the bore on a side of the bore opposite to the entry side. Then, as in the neutral state, it is radially pretensioned against the stop element 36 by means of the holding arm 42.

In order to now produce a chamfer on the side of the bore opposite to the entry side, the cutting tool 10 has to be moved back along the tool axis 12. The reverse chamfer cutting edge 28 can then produce a chamfer on the associated edge of the bore.

Again, among others, cutting forces act on the chamfer cutting element 24 in radial direction. As soon as these exceed the pretensioning introduced by means of the holding arm 42 into the chamfer cutting element 24, the chamfer cutting element 24 shifts back into the interior of the tool body 14 and the cutting tool 10 can be removed from the bore along the tool axis 12.

It is thus possible, in a single machining step, to produce a through-bore in which both the entry or insertion-side edge and the exit-side edge are provided with a chamfer.

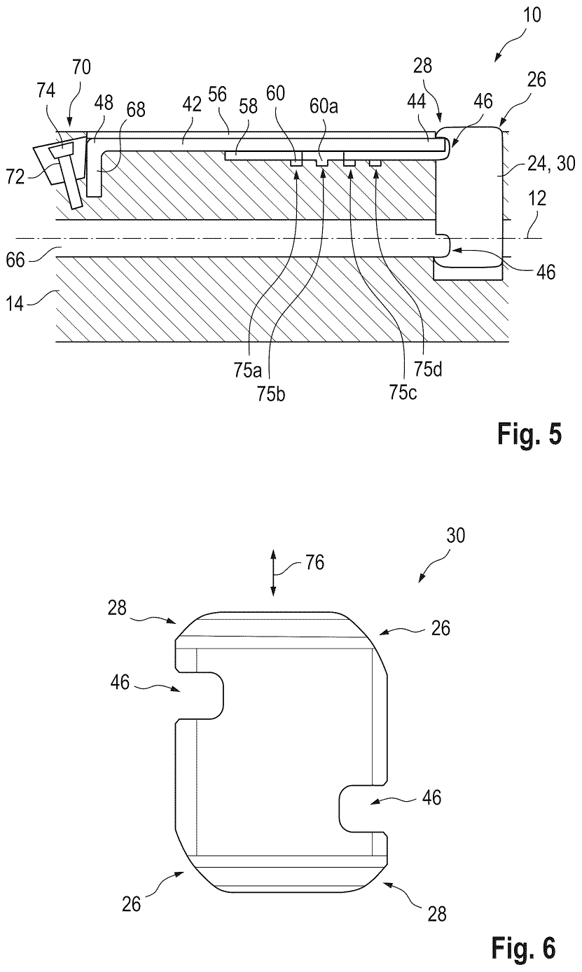

An alternative embodiment of the cutting tool 10 is shown in FIG. 5.

Only the differences to the first embodiment according to FIGS. 1 to 4 will be discussed. The same or corresponding components are provided with the same reference signs.

In the alternative embodiment, the holding arm 42 is produced in one piece with a clamping portion 68 which projects at a substantially right angle from it.

Said clamping portion is disposed in a recess 70 of the tool body 14 and clamped there by means of a frustoconical clamping element 72, which is fastened to the tool body 14 by means of a clamping screw 74.

The bending abutment element 60 is now also changed compared to the first embodiment.

It comprises a fastening extension 60a, which can selectively be inserted into an associated fastening groove 75a, 75b, 75c or 75d on the tool body 14.

Therefore, in order to set a size of the portion of the holding arm 42 which projects relative to the bending abutment element 60, the fastening extension 60a of the bending abutment element 60 can be inserted into a suitable fastening groove 75a to 75d.

In this context, the number of four fastening grooves 75a to 75d is also to be understood as an example. The same applies to the distances between the fastening grooves 75a to 75d, which can be selected depending on the application.

The fastening extension 60a and the fastening grooves 75a to 75d preferably create a press fit, so that the bending abutment element 60 is held securely on the tool body 14.

In all other respects, reference can be made to the explanations relating to the first-mentioned embodiment.

It goes without saying that constructive elements, which are shown in one of the two embodiments, can also be combined in other ways. In particular, the bending abutment element 60 according to the second embodiment can also be used together with a holding arm 42 according to the first embodiment. Likewise, the bending abutment element 60 according to the first embodiment can be used in combination with the holding arm 42 according to the second embodiment.

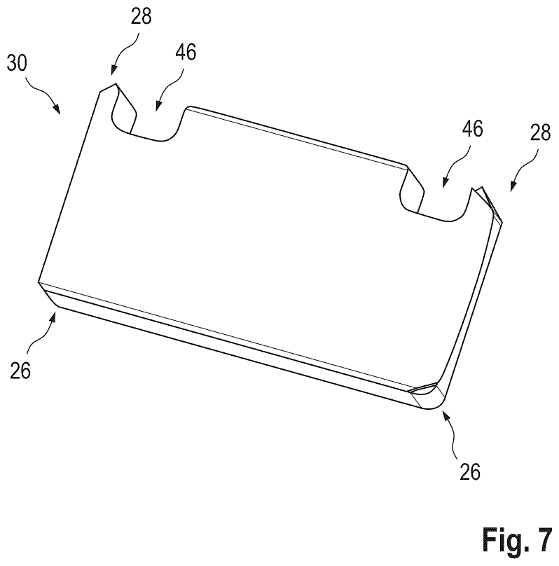

FIGS. 6 and 7 show the indexable inserts 30 used in the two embodiments of the cutting tool 10 in detail.

Each of the indexable inserts 30 comprises a total of two depressions 46, which are configured to interact with the end 44 of the holding arm 42.

The two indexable inserts 30 can thus respectively be used in two installation positions. In each of these installation positions, a forward chamfer cutting edge 26 and a reverse chamfer cutting edge 28 are available.

In total, therefore, the two indexable inserts 30 comprise two forward chamfer cutting edges 26 and two reverse chamfer cutting edges 28.

The indexable inserts 30 according to FIGS. 6 and 7 differ only with respect to the arrangement of the depressions 46, and thus with respect to the movement of the indexable insert 30, which is necessary, starting from a position in which one of the depressions 46 is coupled to the end 44 of the holding arm 42, to reach a position in which a respective other one of the depressions 46 can be coupled to the end 44 of the holding arm 42.

In the embodiment according to FIG. 6, the two depressions 46 are positioned on opposite sides of the indexable insert 30 and are also offset to one another in a direction 76 parallel to the two opposite sides.

In the embodiment according to FIG. 6, the two depressions 46 are configured on the same side.

It goes without saying that the embodiments according to FIG. 6 and FIG. 7 can also be combined. A resulting indexable insert 30 is thus provided with a total of four depressions 46 and comprises a total of four forward chamfer cutting edges 26 and four reverse chamfer cutting edges 28. The indexable insert 30 can consequently be used in four different installation positions.

1. A cutting tool comprising
a tool body which is rotatable about a tool axis and having an axially extending groove on the outer periphery of the tool body,
a chamfer cutting element mounted on the tool body that is radially displaceable, the chamfer cutting element having at least one forward chamfer cutting edge and at least one reverse chamfer cutting edge,
a bending abutment element axially adjustable within the axially extending groove, and
a holding arm separate from the chamfer cutting element, which holds the chamfer cutting element in a radial direction on the tool body,
wherein the holding arm is positioned on top of the bending adjustment element such that the holding arm is elastically flexible in radial inward and outward direction and the deformation characteristic of the holding arm can be adjusted by axial adjustment of the position of the bending abutment element within the axially extending groove.

2. Cutting tool according to claim 1, wherein a cutting bit is disposed on a front end of the tool body.

3. Cutting tool according to claim 1, wherein the holding arm extends substantially in axial direction.

4. Cutting tool according to claim 3, wherein the holding arm comprises a first, axially forward end, which engages in an associated depression on the chamfer cutting element.

5. Cutting tool according to claim 4, wherein the holding arm comprises a second, axially rear end, which is fastened to the tool body.

6. Cutting tool of claim 3, wherein a recess is provided on the tool body adjacent in radial direction to at least one axially forward region of the holding arm and is configured to receive the holding arm in the event of a radially inward elastic deformation.

7. Cutting tool according to claim 6, wherein the recess extends from the axially forward end of the holding arm over at least 50% of the length of the holding arm.

8. Cutting tool according to claim 1, wherein the guide is formed by a guide channel which extends in radial direction in the tool body, into which at least a portion of the chamfer cutting element is inserted, wherein the guide channel is open on one side.

9. Cutting tool according to claim 8, wherein the tool body comprises a cooling channel which extends substantially axially and substantially over the entire length of the tool body.

10. Cutting tool according to claim 1, wherein the chamfer cutting element is an indexable insert.

11. Cutting tool according to claim 1, wherein the holding arm is strip-shaped.

12. Cutting tool according to claim 1, wherein a stop element is provided on the tool body and abutting the chamfer cutting element for limiting a displacement path of the chamfer cutting element radially outward.

13. Cutting tool according to claim 12, wherein the stop element is adjustable in its radial position.

14. Indexable insert for a cutting tool according to claim 1, wherein an indexable insert body comprises, on each of two opposite sides, a depression which is configured to interact with one end of the holding arm, wherein the depressions are offset to one another along a direction parallel to the two opposite sides, or comprises two depressions on one side, which are configured to interact with one end of a holding arm.

15. Cutting tool of claim 5, wherein the second, axially rear end is clamped or screwed to the tool body.

16. Cutting tool of claim 7, wherein the recess extends over at least 65% of the length of the holding arm.

17. Cutting tool of claim 10, wherein the cooling channel is fluidly connected to the guide channel.

18. Cutting tool of claim 12, wherein the holding arm is configured as a sheet metal strip.

19. Cutting tool of claim 14, wherein the stop element is a stop screw which is screwed radially into the tool body.
